(19) United States
(12) Patent Application Publication
(10) Pub. No.: US 2004/0052373 A1
(43) Pub. Date: Mar. 18, 2004

(54) Quantum cryptography method and system

(76) Inventor: Thierry Debuisschert, Orsay (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/416,186

(22) PCT Filed: Nov. 9, 2001
(86) PCT No.: PCT/FR01/03501

(30) Foreign Application Priority Data
Nov. 10, 2000 (FR) 00 14489

(51) Int. Cl. H04K 1/00

(52) U.S. Cl. 380/255

(57) ABSTRACT

Quantum cryptography by polarization ambiguity is generally used but it involves polarization-maintained fibers.

This invention proposes an alternative: quantum cryptography by encoding on the phase of the interferogram of a particle flow. It comprises the conversion of a sequence of K bits of digital data into a train of K interferograms of particle flows of duration and frequency T, the state of the interferogram of the k^{th} period depending on the value of the corresponding K bits.

The invention concerns the field of cryptography.

Through the use of cryptography, a message can only be read by its recipient. A key is used to encrypt the message. The owner of the key is the only person who can read the message received.

The encryption key must therefore be transmitted by the sender to the recipient of the encrypted message. Transmission is carried out such that only the recipient of the encrypted message receives this encryption key. Interception by a third party of the encryption key is detected by the sender or the recipient. Consequently, the encryption key or the elements of the key detected as having been intercepted are not used to encrypt the message.

The principle of transmitting encryption keys is used, for example, in quantum cryptography. It consists of using physical properties to guarantee the integrity of a received encryption key.

The encryption key consists of a bit sequence. Generally, a photon polarization state is associated with each bit. The light flow, encoded by polarization, is then attenuated. The probability of detecting two photons associated with the same bit is then negligible.

The sender can encode the encryption key on two nonorthogonal states (a given polarization state and a state at 45°). Concerning this subject, Bennett wrote the article “Quantum Cryptography using any two Nonorthogonal states” in Physics Review letters 68 in 1992. In reception, the detection states are chosen in a base with two states. These two detection states are orthogonal respectively to each state of the base used by the sender. During transmission, the transmission and detection states are chosen independently of each other.

If the states chosen by the transmitter and the receiver are orthogonal, the detection probability is zero. The measurement result is certain, there is no ambiguity. If they are not orthogonal, there are two possible measurement results since the probability of detecting the photon is 0.5. If the photon is detected, it is certain that the transmitter state is at 45° to the receiver state. There is no ambiguity. Irrespective of the polarization configuration, there is always a possibility of not detecting the photon. This non detection of the photon makes deducing the choice of transmitter polarization, using the receiver state, ambiguous.

This ambiguity concerning the polarization is used in quantum cryptography. A non recipient cannot reproduce the message since it is impossible to avoid losing information.

This type of quantum cryptography is known as “polarization ambiguity quantum cryptography” since it uses photon polarization states. A certain number of problems are involved. They concern the encoding of the encryption key on the polarization states of the photons in a light flow. During transmission, there is a problem of polarization distortion. For example, transmission by optical fibers requires complex systems which are difficult to implement and very expensive. For example,

either the use of polarization-maintained fibers, which are expensive and difficult to implement,

or the use of complex systems implementing, for example, Faraday rotators.

This invention proposes an alternative. The data to be transmitted, for example the encryption key, is encoded on the phase of an interferogram. The particle flow carrying the encoded interferogram is transmitted using the principle of quantum cryptography. The implementation of quantum cryptography by encoding on the phase is simpler than that on the polarization. Encoding on the phase, in fact, generates a time shift in the shape of the interferogram. However, two photons transmitted successively with a time difference Δt will be received in the transmission order, independently of the transmission medium.

The invention proposes a digital data encoding method intended for the transmission of particles such that the probability of transmitting two particles per period is negligible, wherein it comprise at least the conversion of a sequence of K bits of digital data into a train of K interferograms of particle flows of duration and frequency T, the state of the interferogram of the k^{th} period depending on the value of the corresponding bit (k≦K, where K is an integer greater than or equal to one).

The invention proposes a method to decode encoded digital data, wherein it comprises at least the observation of the particle flow received on at least one time window of predetermined duration Δt placed on a point of the period k such that if a photon is detected, the probability that the interferogram state is detected is 100%.

The decoding method is implemented by a decoder of digital data encoded by the encoder, wherein it is used to observe the particle flow received on a time window of predetermined duration Δt placed on a given point of the period k of the interferogram of one of 2N encoding states.

The advantages and features of the invention will be clearer on reading the following description, given as an example, illustrated by the attached figures representing in:

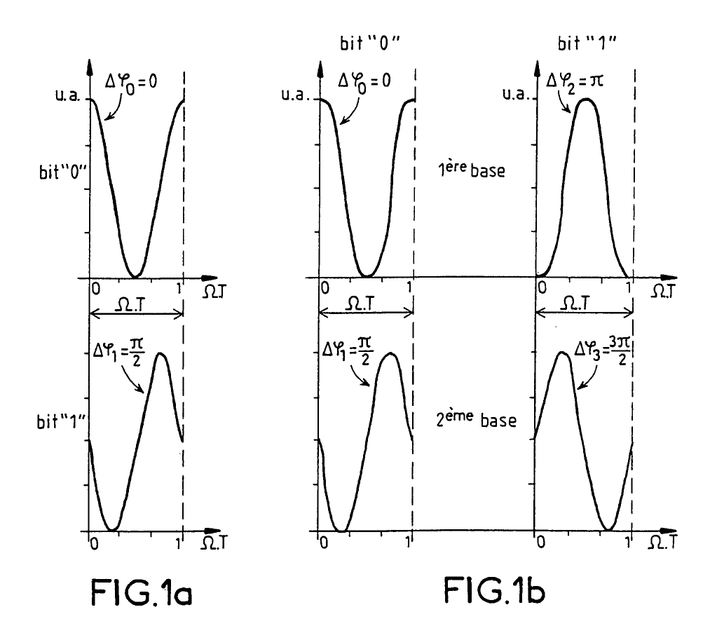

FIGS. 1(a) and (b), a representation of the encoding, respectively, on 2 and 4 states on the phase of the interferogram of the particle flow,

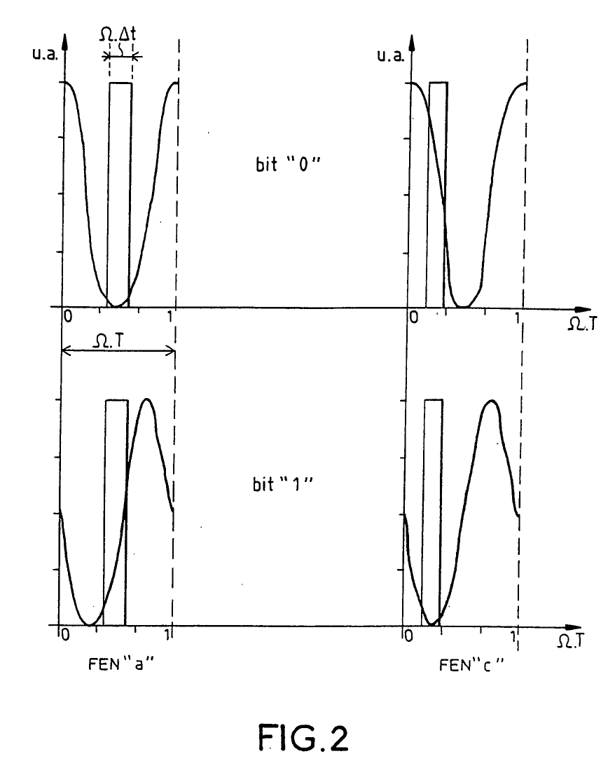

FIG. 2, a representation of the reception of data by a receiver in the event of encoding on two states,

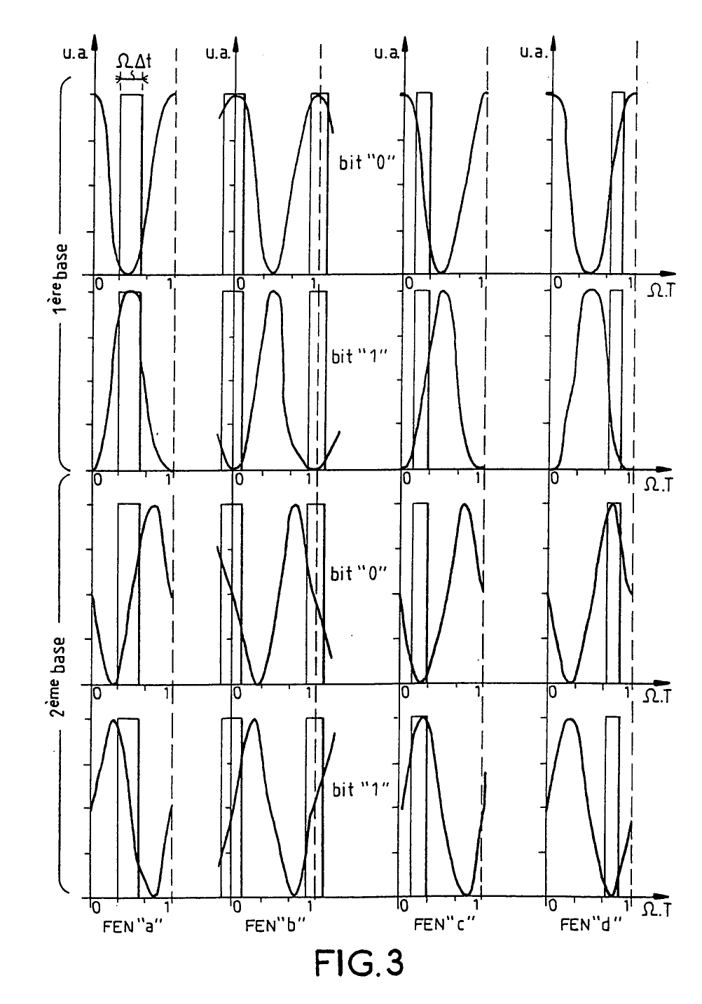

FIG. 3, a representation of the reception of data by a receiver which has one observation window, in the event of encoding on four states,

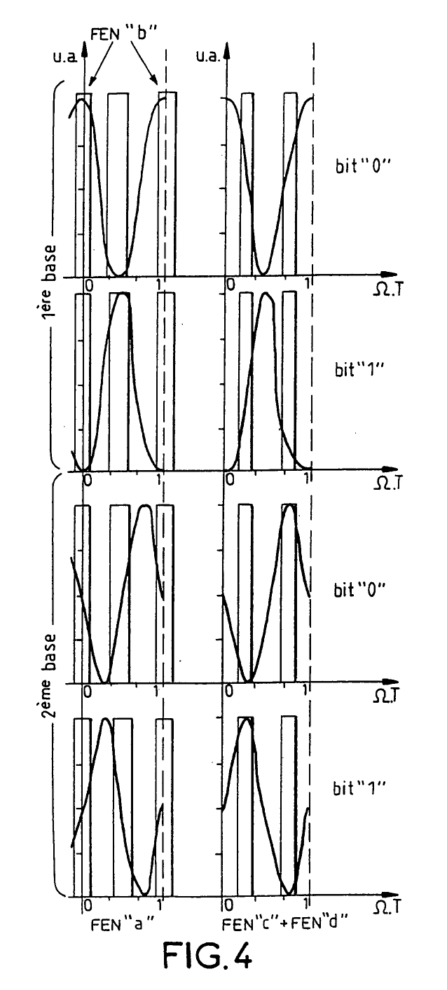

FIG. 4, a representation of the reception of data by a receiver which has two observation windows, in the event of encoding on four states,

FIG. 5, a quantum cryptography transmitter including a first variant of the encoder according to the invention,

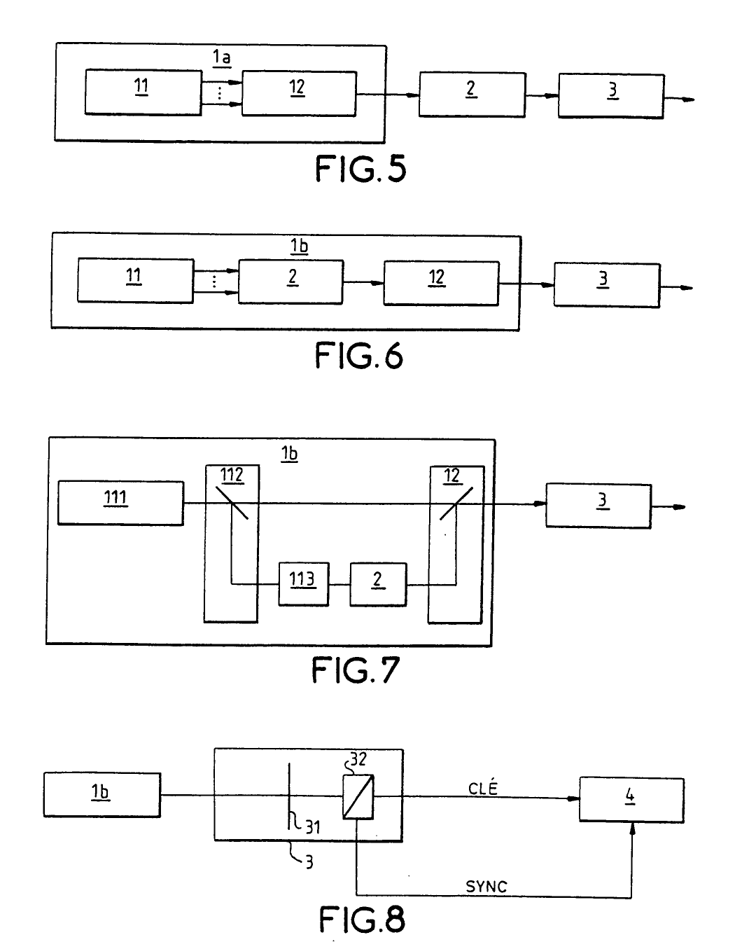

FIG. 6, a quantum cryptography transmitter including a second variant of the encoder according to the invention,

FIG. 7, a detailed example of realization of the encoder according to the invention in the variant shown on FIG. 6,

FIG. 8, a detailed example of realization of the attenuator 3 of the transmitter of FIG. 6 in a quantum cryptography transmission system.

The encoding principle proposed by the invention is as follows. Interference is generated on a particle flow in the time domain. The data is then encoded on the phase of the time interferogram of this flow. The expression of the electric field results from the superposition of two modes of distinct frequencies. It is given to within a constant by the expression:

E(z,t)=α₁exp(i(k₁z−ω₁t))+α₂exp(i((k₂z−ω₂t))

where α₁ and α₂ represent the complex amplitudes of the two modes; k₁ and k₂ are the wave vectors and ω₁ and ω₂ are the frequencies. In the simplest case where the two modes have the same amplitude a and phases φ₁ and φ₂, the probability of detecting a photon is proportional to:

W₁=α²(1+cos(Δφ+Kz+Ωt)), where Δφ=φ₁−φ₂, K=k₁−k₂ and Ω=ω₁−ω₂

The message is encoded in time. The distance z between the transmitter (1, 2 and 3) and the receiver 4 is unimportant, it simply adds a phase term. In this case, the probability of detecting a photon is a sinusoidal function of time.

The interferometer is balanced if the intensities are identical in both modes. In this case, the probability of detection is zero at regular intervals of period T=2π/Ω. Each sine arch can form a data bit as shown on FIGS. 1(a), 1(b), 2(b) and 3(b).

The quantum cryptography regime involves attenuating the particle flow. The attenuation is such that the probability of detecting two photons per period is negligible.

Consider, for example, the case of encoding on two states shown on FIGS. 1(a) and 2.

Encoding on the phase of the time interferogram is suitable for encoding on two nonorthogonal states as shown on FIG. 1(a). The two states are chosen by the transmitter using the phase difference between the two modes. For example, the bit of value “0” can be associated with dephasing Δφ₀=0 and the bit of value “1” with dephasing Δφ₁=π/2 and vice versa. The beam is attenuated to obtain a probability α² of detection of 0.1 photons per bit. The intensity of the transmitted beam is therefore α²Ω/2π.

The receiver must be able to use the orthogonal states on two states transmitted as shown on the example of FIG. 2. Consequently, the photons are only observed during a given time window of duration Δt.

The receiver is synchronized with the transmitter. The direction in which the interferogram is shifted with respect to the clock signal is part of the transmission protocol shared by the transmitter and the receiver.

The time window is therefore shifted according to this protocol by a quarter period or a half period such that it coincides with the zeros of the interferogram of one of the states.

Generally, the dephasing on transmission is chosen equal to Δφ₀ or Δφ₁ by the transmitter independently of the receiver. Similarly, the state (Δφ₀ or Δφ₁) is chosen by the receiver independently of the transmitter.

The receiver is faced with four possible cases. For example, if the observation window of the receiver is the window “a”, the various possible cases are those shown on the left of FIG. 2.

(WINDOW “A”, BIT “0”) If a bit of value “0” has been transmitted, the time window of the given period is on an interference zero. In this case, the probability of detection is very low.

(WINDOW “A”, BIT “1”) If a bit of value “1” has been transmitted, the window of the given period is in quadrature with the interferogram. In this case, the probability of detecting a photon is high. In addition, knowing the base it has chosen, the receiver automatically detects the value of the transmitted bit. The information is transmitted.

If the observation window of the receiver is the window “b”, the various possible cases are those shown on the right of FIG. 2.

(WINDOW “B”, BIT “0”) If a bit of value “0” has been transmitted, the window of the given period is in quadrature with the interferogram. In this case, the probability of detecting a photon is high. In addition, knowing the base it has chosen, the receiver automatically detects the value of the transmitted bit. The information is transmitted.

(WINDOW “B”, BIT “1”) If a bit of value “1” has been transmitted, the time window of the given period is on an interference zero. In this case, the probability of detection is very low.

If no photons are detected, the receiver cannot determine for certain which base was chosen by the transmitter. The ambiguity results from non detection of photons. This ambiguity can be used by the receiver to detect possible spying on the channel by a third party.

Summing up, if the photon counter detects a photon in the observation window centered on the minimum of the period k of the interferogram dephased by Δφ₁, respectively by Δφ₀ with 2N=2 encoding states, the decoder supplies the digital data corresponding to the inverse state Δφ₀, respectively Δφ₁.

The duration Δt of the time window can be determined from specifications. It may, for example, include limits or values of the probability of false alarm and/or the error probability and/or the signal probability. The probability of detecting a photon present depends on the opening duration Δt of the observation window with respect to the period of the interferogram. This probability is also called the signal probability. It is given by the following expression:

$$signal = \frac{Δ t}{T}$$

When the states chosen by the receiver and the transmitter are in phase opposition, the probability of detecting the photon is non zero. It would only be zero at the limit, i.e. for Δt=0. Consequently, there is an intrinsic probability of false alarm given by the following expression:

$$falsealarm = \frac{Δ t}{T} - \frac{sin ( π \frac{Δ t}{T} )}{π}$$

The error rate can be defined as the ratio between the probability of false alarm and the probability of detecting a photon:

$$error = \frac{falsealarm}{falsealarm + signal}$$

We will now consider the case of encoding on four states shown on FIGS. 1(b) and 3.

Its four states can be used to form nonorthogonal bases two by two. In the example shown on FIG. 1(b), the first base is formed by the interferograms dephased by Δφ₀=0 and Δφ₂=π, the second by the interferograms dephased by Δφ₁=π/2 and Δφ₃=3π/2. In addition, in this example, each state is associated with a bit of the sequence of digital data bits forming the information to be transmitted. For example, a bit of value “0” can be associated either with the first state Δφ₀, or the second state Δφ₁ and a bit of value “1” can be associated either with the third state Δφ₃, or the fourth state Δφ₃. Consequently, for each bit to be transmitted, the transmitter must choose the base to be used. This example is not limiting for the dephasing values, for the bases chosen or for the associations.

The receiver 4 is synchronized with the transmitter. The duration of the synchronization signal period is Ω T. The transmitter and the receiver agree in which direction the interferograms are shifted. The receiver then decides to position its observation window, not shifting it or shifting it by a quarter period, half period or three quarters of a period. The window is then positioned on the minima of the interferogram corresponding to one of the four states that the transmitter can produce. The receiver is faced with four possible cases. For example, if the observation window of the receiver is the window “a” of FIG. 3, the various possible cases are the four cases at the extreme left of FIG. 3.

(WINDOW “A”, 1^{ST} BASE, BIT “0”) If a bit of value “0” has been transmitted using the first base, the time observation window of the given period is on an interference zero. In this case, the probability of detection is very low.

(WINDOW “A”, 1^{st} BASE, BIT “1”) If a bit of value “1” has been transmitted using the first base, the window of the given period is in phase with the interferogram. In this case, the probability of detecting a photon is maximum. The receiver knows the base it chose. It therefore detects the value transmitted. The information is transmitted.

(WINDOW “A”, 2^{ND} BASE, BIT “0” and “1”) If a bit has been transmitted using the second base, the window of the given period is in quadrature with the interferogram received. In this case, the probability of detecting a photon is high.

If the observation window of the receiver is the window “b” of FIG. 3, the various possible cases are the four cases at the left center of FIG. 3.

(WINDOW “B”, 1^{ST} BASE, BIT “0”) The window of the given period is in phase with the interferogram. In this case, the probability of detecting a photon is maximum. The receiver knows the base it chose. It therefore detects the value transmitted. The information is transmitted.

(WINDOW “B”, 1^{ST} BASE, BIT “1”) The time observation window of the given period is on an interference zero. In this case, the probability of detection is very low.

(WINDOW “B”, 2^{ND} BASE, BIT “0” AND “1”) The window of the given period is in quadrature with the interferogram received. In this case, the probability of detecting a photon is high.

If the observation window of the receiver is the window “c” of FIG. 3, the various possible cases are the four cases at the right center of FIG. 3.

(WINDOW “C”, 1^{ST} BASE, BIT “1” AND “1”) The window of the given period is in quadrature with the interferogram received. In this case, the probability of detecting a photon is high.

(WINDOW “C”, 2^{ND} BASE, BIT “0”) The time observation window of the given period is on an interference zero. In this case, the probability of detection is very low.

(WINDOW “C”, 2^{ND} BASE, BIT “1”) The window of the given period is in phase with the interferogram. In this case, the probability of detecting a photon is maximum. The receiver knows the base it chose. It therefore detects the value transmitted. The information is transmitted.

If the observation window of the receiver is the window “d” of FIG. 3, the various possible cases are the four cases at the extreme right of FIG. 3.

(WINDOW “D”, 1^{ST} BASE, BIT “0” AND “1”) The window of the given period is in quadrature with the interferogram received. In this case, the probability of detecting a photon is high.

(WINDOW “D”, 2^{ND} BASE, BIT “0”) The window of the given period is in phase with the interferogram. In this case, the probability of detecting a photon is maximum. The receiver knows the base it chose. It therefore detects the value transmitted. The information is transmitted.

(WINDOW “D”, 2^{ND} BASE, BIT “1”) The time observation window of the given period is on an interference zero. In this case, the probability of detection is very low.

Summing up, if the photon counter detects a photon in the observation window centered on the maximum of the period k of the interferogram dephased by Δφ corresponding to one of the encoder states, the decoder supplies the digital data corresponding to this state Δφ comparison of the choice of bases between transmitter and receiver.

As for the encoding on two states, the duration Δt of the observation window can be determined from specifications. These specifications include limits or values of the probability of false alarm and/or the error probability and/or the signal probability.

The probability of detecting the photon is, in this case, higher than with encoding on two states. Its expression is given by:

$$signal = \frac{Δ t}{T} - \frac{sin ( π \frac{Δ t}{T} )}{π}$$

The states chosen by the transmitter and the receiver can be different. When the states chosen by the receiver and the transmitter are in phase opposition, the probability of detecting the photon is non zero. This corresponds to windows on the minima of the interferogram. It also results in a probability of false alarm. Its expression is similar to that obtained for encoding on two states:

$$falsealarm = \frac{Δ t}{T} - \frac{sin ( π \frac{Δ t}{T} )}{π}$$

Otherwise, the windows are in quadrature with the interferogram. The probability of detection is non zero. These measurements will be rejected, however, when the transmitter and the receiver compare the choice of their bases. The error rate can be calculated as before. It depends on the signal probability and the probability of false alarm:

$$error = \frac{falsealarm}{falsealarm + signal}$$

FIG. 4 shows an example of reception with two observation windows when using encoding on 4 states. The two windows are chosen so that they are positioned on the minima of the interferograms on one or the other of the bases used by the transmitter.

When the observation windows of receiver 4 are windows win“a” and win“b”, as on the left side of FIG. 4, the various possible cases are:

(WINDOW “A+B”, 1^{ST} BASE, BIT “0”) The time observation window “a” of the given period is on an interference zero. In this case, the probability of detection is very low. The window “b” of the given period is in phase with the interferogram. In this case, the probability of detecting a photon is maximum. The receiver knows the base it chose. It therefore detects the value “0” transmitted. The information is transmitted.

(WINDOW “A+B”, 1^{ST} BASE, BIT “1”) The time observation window “b” of the given period is on an interference zero. In this case, the probability of detection is very low. The window “a” of the given period is in phase with the interferogram. In this case, the probability of detecting a photon is maximum. The receiver knows the base it chose. It therefore detects the value “1” transmitted. The information is transmitted.

(WINDOW “A+B”, 2^{ND} BASE) The windows win“a” and win“b” of the given period are in quadrature with the interferogram received. In this case, the probability of detecting a photon in the two windows is high.

When the observation windows of receiver 4 are windows win“c” and win“d”, as on the right side of FIG. 4, the various possible cases are:

(WINDOW “C+D”, 1^{ST} BASE) The windows win“c” and win“d” of the given period are in quadrature with the interferogram received. In this case, the probability of detecting a photon in the two windows is high.

(WINDOW “C+D”, 2^{ND} BASE, BIT “0”) The time observation window “c” of the given period is on an interference zero. In this case, the probability of detection is very low. The window “d” of the given period is in phase with the interferogram. In this case, the probability of detecting a photon is maximum. The receiver knows the base it chose. It therefore detects the value “0” transmitted. The information is transmitted.

(WINDOW “C+D”, 2^{ND} BASE, BIT “1”) The time observation window “d” of the given period is on an interference zero. In this case, the probability of detection is very low. The window “c” of the given period is in phase with the interferogram. In this case, the probability of detecting a photon is maximum. The receiver knows the base it chose. It therefore detects the value “1” transmitted. The information is transmitted.

FIGS. 5 to 7 show several examples of realizing a transmitter according to the invention. The particle flow producing the interferogram at the output of device 1a or 1b is, for example, a light flow. The light flows generated by the source 11 of device 1a or 1b are distinct. They are in fact shifted in frequency. A recombination element 12 receives them. It recombines them into a flow which displays interference. The probability of detecting a photon is then periodically zero. The encoding is carried out by the dephasing device 2. The information is encoded on the phase of the interferogram. The attenuator 3 brings the quantum cryptography regime. The encoded flow is therefore attenuated. The probability of detecting two photons per period is then negligible.

The transmitter produces a coherent state. This state is robust with respect to disturbance, especially losses. Discretization into bits is carried out automatically. With encoding on two states, a bit is associated with each period between two positions with zero probability of detection. With encoding on four states, only the encoding process is different.

The signal output from the decoder is not very sensitive to the disturbance suffered by the beam during propagation. The frequencies of the two modes used are in fact very close. Consequently, they suffer similar disturbance. The types of disturbance suffered are birefringence of the propagation medium, wave front distortion, dephasing, laser phase diffusion, etc. All these types of disturbance cancel out in the interference signal detected.

FIGS. 5 and 6 propose two variants of the encoder. The first variant is shown on FIG. 5. The interferogram output from device 1a is “blank”. In this case, the dephasing device 2 is downstream from the interferometer 1a. The second variant is shown on FIG. 6. In this case, however, the dephasing device 2 is part of the interferometer 1b. It is between the source 11 and the recombination element 12.

More generally, this second variant includes a dephasing device 2 which receives the F particle flows upstream from the superposition element and dephases each of the F particle flows such that the interferogram output from the superposition element is encoded with the sequence of K bits of digital data.

FIG. 7 shows a detailed example of realizing the interferometer 1b of the encoder on FIG. 6.

A light beam is supplied by a source 111. This source 111 is, for example, a single mode laser. A separation element 112 receives the beam and splits it into two parts. It includes, for example, a half-wave plate. The resulting two beams have identical modes, frequencies ω₁, and phases φ₁. The first beam is transmitted directly. To produce interference, the two beams must, for example, be shifted in frequency. The frequency of the second beam is therefore translated (ω₁→ω₂). This is carried out by a device 113. This device 113 is an acousto-optical or electro-optical modulator, etc. The second beam is also dephased. The dephasing Δφ((φ₁→φ₂=Δφ) depends on the information to be transmitted. It is carried out by device 2. The two beams are then recombined using the recombination element 12. This recombination can be carried out, for example, making sure that the two beams have the same intensity. The resulting beam is bimode. It is supplied by the interferometer 1b to the attenuator 3.

The source 11 can be a bimode laser if the phase diffusion of each mode is sufficiently low. The beat frequency and therefore the pitch of the fringes is chosen and optimized. This is carried out to take into account the detector constraints and/or the information transmission frequency. The detector constraints include the minimum duration of the time window, the minimum delay between two windows, etc.

The transmitter may have other structures. For example, the function of the time interferogram can be more complicated. The spectra of the sources 11 and the interferometers 1a or 1b then have a wider range of frequencies. They include a multimode source, a mode-locked laser, etc. Such structures make the interferogram function more “square”. For example, the function is periodic, Gaussian or door type, etc. The signal probability therefore increases whereas the probability of false alarm drops.

FIG. 7 shows an example of attenuator 3 in a transmission system. The transmission system is that of FIG. 4 with the second variant of the encoder. The attenuator 3 includes a half-wave plate 31. It is followed by a polarizer 32. It produces two beams: a “key” attenuated beam and a secondary beam. The intense beam leaving by the secondary channel can also be transmitted to the receiver. It is used, for example, to create a “sync” reference signal to synchronize the clock of receiver 4. In particular, it is used to synchronize the detection. The “sync” signal is transmitted either directly in optical format or as a microwave signal, etc.

Receiver 4 shown on FIG. 8 includes a photon counter activated only during observation windows. The observation windows shown on FIG. 2(a) are those used during encoding on two states and those of FIG. 3(a) during the encoding on four states. Following the detection of a photon in the “key” quantum signal by the photon counter 41 in one or the other of the observation windows, the receiver 4 decides whether a bit of value “0” or “1” has been transmitted. If the photon counter 41 does not detect any photons in one or the other of the observation windows, the receiver 4 decides that there is non-reception.

For example, if the receiver 4 has:

a single observation window as on FIGS. 2 and 3, whether the encoding is on two or four states, in case of non-detection, receiver 4 cannot distinguish between the particles not detected since not received, intercepted or in another state.

two observation windows as on FIG. 4, with encoding on four states, in case of non-detection of a particle, receiver 4 cannot decide whether the non-detection is due to interception of the particle or to non-reception.

More generally, all sources of particle beams (electrons, positrons, etc.) may be considered. In addition, the examples of realization describe the creation of an interferogram using two waves of distinct modes. More generally, we may therefore consider the superposition of F waves of distinct modes which would produce interferograms with pulses much better defined in time that the sine wave.

1. Digital data encoding method intended for the transmission of particles such that the probability of transmitting two particles per period is negligible, wherein it comprises at least the conversion of a sequence of K bits of digital data into a train of K interferograms of particle flows of duration and frequency T, the state of the interferogram of the k^{th} period depending on the value of the corresponding bit (k≦K, where K is an integer greater than or equal to one).

2. Encoding method according to the previous claim, wherein the interferogram has one or more of the following characteristics:
it is zero at regular intervals of duration T,
it is generating by superposing several particle flows, either of distinct modes or shifted in frequency,
it is either sinusoidal, Gaussian type or door type.

3. Encoding method according to one of the previous claims, wherein the various interferogram states correspond to various dephasings of the interferogram and form two by two N nonorthogonal bases (where N is an integer greater than or equal to one).

4. Encoding method according to the previous claim, wherein the interferogram is dephased according to one of the following algorithms:
if the encoded method uses a single base (N=1) and
if the value of the k^{th} bit of the digital data sequence is “0”, the interferogram of the k^{th} period is dephased by Δφ₀,
if the value of the k^{th} bit of the digital data sequence is “1”, the interferogram of the k^{th} period is dephased by Δφ₁≠Δφ₀.
if the encoding method uses two bases (N=2),
if the value of the k^{th} bit of the digital data sequence is “0”, the interferogram of the k^{th} period is dephased by Δφ₀ or Δφ₁ depending on the base chosen,
if the value of the k^{th} bit of the digital data sequence is “1”, the interferogram of the k^{th} period is dephased by Δφ₂ or Δφ₃ depending on the base chosen.

5. Encoding method according to one of the previous claims, wherein it has at least one of the following characteristics:
the particle flow(s) are light flows, photon flows, electron flows or positron flows;
the digital data has at least one encryption key.

6. Digital data transmission method comprising at least one digital data encoding step according to the method of one of claims 1 to 5 followed by an attenuation step to reduce the number of particles transmitted per period so that the probability of transmitting two particles per period of duration T is negligible.

7. Digital data encoder intended for the transmission of particles such that the probability of transmitting two particles per period is negligible, wherein it is used at least to convert a sequence of K bits of digital data into a train of K interferograms of particle flows of duration and frequency T, the state of the interferogram of the k^{th} period depending on the value of the corresponding bit (k≦K).

8. Encoder according to the previous claim, wherein it comprises at least one interferometer generating a particle flow with either a blank interferogram or an interferogram on which the digital data is encoded.

9. Encoder according to the previous claim, wherein the interferometer comprises at least one element for the superposition of F particle flows (F>1).

10. Encoder according to claim 8, wherein it comprises at least the particle flow generator placed upstream from the superposition element and comprising:
either a multimode source,
or a bimode laser (if F=2),
or a mode-locked laser,
of Ff single mode lasers shifted in frequency,
or a single mode laser followed by a separation element generating F particle flows and a distinct frequency shifting element on each path of the F particle flows.

11. Encoder according to one of claims 7 to 9, wherein it comprises an interferogram dephasing device receiving the data to be encoded and introducing a dephasing such that the interferogram of the k^{th} period output from the encoder is dephased according to the value of the digital data bit associated with this period.

12. Encoder according to one of the previous claims, wherein the various interferogram states correspond to various dephasings of the interferogram and form two by two N nonorthogonal bases (where N is an integer greater than or equal to one).

13. Encoder according to the previous claim, wherein the interferogram is dephased according to one of the following algorithms:
if the encoder uses a single base (N=1) and
if the value of the k^{th} bit of the digital data sequence is “0”, the interferogram of the k^{th} period is dephased by Δφ₀,
if the value of the k^{th} bit of the digital data sequence is “1”, the interferogram of the k^{th} period is dephased by Δφ₁=Δφ₀.
if the encoder uses two bases (N=2),
if the value of the k^{th} bit of the digital data sequence is “0”, the interferogram of the k^{th} period is dephased by Δφ₀ or Δφ₁ depending on the base chosen,
if the value of the k^{th} bit of the digital data sequence is “1”, the interferogram of the k^{th} period is dephased by Δφ₂ or Δφ₃ depending on the base chosen.

14. Encoder according to one of claims 8 to 12, wherein the dephasing device receives the F particle flows upstream from the superposition element and dephases each of the F particle flows such that the interferogram output from the superposition element is encoded with the sequence of K bits of digital data.

15. Encoder according to one of claims 7 to 13, wherein it has at least one of the following characteristics:
the particle flow(s) are light flows, photon flows, electron flows or positron flows;
the digital data has at least one encryption key.

16. Digital data transmitter comprising at least one digital data encoder according to one of claims 7 to 14 downstream from an attenuator to reduce the number of particles transmitted per period so that the probability of transmitting two particles per period ΩT is negligible.

17. Transmitter according to the previous claim, wherein it has one or more of the following characteristics:
when the particle flow is a light flow, the attenuator comprises at least one half-wave plate receiving the particle flow in which the train of pulses corresponding to the sequence of bits to be encoded has been chopped and followed by a polarizer producing two beams, one of which is the attenuated transmitted beam, for which the probability of two photons being transmitted per period Tb is negligible.
the second beam produced by the polarizer forms a secondary beam used to synchronize the transmitter and the receiver;
it is a quantum cryptography transmitter;

18. Method to decode digital data encoded according to the method of one of claims 1 to 5, wherein it comprises at least the observation of the particle flow received on at least one time window of predetermined duration Δt placed on a point of the period k such that if a photon is detected, the probability that the interferogram state is detected is 100%.

19. Decoding method according to the previous claim, wherein it comprises one of the following steps:
if the encoding is on 2N=2 states, the decision that a bit of value “0”, respectively of value “1”, has been transmitted if a particle has been detected in the observation window placed in quadrature of the period k of the interferogram dephased by Δφ₀, respectively by Δφ₁;
if the encoding is on 2N=4 states, the comparison of the choice of bases between the transmitter and the receiver, and the decision that the data transmitted corresponds to an interferogram dephased by Δφ(Δφ=Δφ₀ or Δφ₁ or Δφ₂ or Δφ₃) if a particle has been detected in the observation window placed on the maximum of the period k of the interferogram dephased by Δφ.

20. Method for the reception of digital data transmitted according to the method of claim 6, comprising a decoding step according to the method of claim 17 or 18, wherein it is a quantum cryptography reception method.

21. Decoder of digital data encoded by the encoder of claim 7 or 14, wherein it is used to observe the particle flow received on a time window of predetermined duration Δt placed on a given point of the period k of the interferogram of one of 2N encoding states.

22. Decoder according to the previous claim, wherein it comprises a photon counter activated on the observation window at each period of duration T.

23. Decoder according to the previous claim, wherein, if the photon counter detects a photon in the observation window centered on:
either the minimum of the period k of the interferogram dephased by Δφ₁, respectively by Δφ₀ on 2N=2 encoding states, the decoder supplies the digital data corresponding to the inverse state Δφ₀, respectively Δφ₁.
or the maximum of the period k of the interferogram dephased by Δφ corresponding to one of the encoder states, the decoder supplies the digital data corresponding to this state Δφ and there is a comparison of the choice of bases between transmitter and receiver.

24. Quantum cryptography transmission system comprising at least one transmitter according to claim 15 or 16 and a receiver which comprises at least one decoder according to claim 20 or 22.
